(19) United States
(12) Patent Application Publication
(10) Pub. No.: US 2014/0278268 A1
(43) Pub. Date: Sep. 18, 2014

(54) METHOD FOR MAPPING ELEMENTS OF A CONSTRUCTION PROJECT

(71) Applicant: ITI- INNOVATIVE TECHNOLOGY INC., Ottawa (CA)

(72) Inventor: Leslie G. Woolsey, Ottawa (CA)

(73) Assignee: ITI- INNOVATIVE TECHNOLOGY INC., Ottawa (CA)

(21) Appl. No.: 13/834,565

(22) Filed: Mar. 15, 2013

(51) Int. Cl. G06F 17/50

(52) U.S. Cl. CPC G06F 17/5004
USPC 703/1

(57) ABSTRACT

A method includes using a process in execution on a processor of a computer system to generate a data file, which includes first data indicative of a classification of an element of a construction project. In particular, the classification is in accordance with a first classification standard such as the UniFormat classification standard. The data file includes second data associated with the first data, the second data indicative of at least a label that is descriptive of the element. The at least a label is not in accordance with the first classification standard. The method further includes implementing filtering rules based on the at least a label. Responsive to the first data and the second data and the filtering rules, the element is automatically mapped to a unique number and title of a second classification standard, such as for instance the MasterFormat classification standard.

### FIELD OF THE INVENTION

The invention relates generally to the mapping of data between different documents associated a construction project, and more particularly to a computer-aided method for automatically resolving one-to-many and many-to-many mapping conflicts when mapping between files that are based on different classification standards.

### BACKGROUND OF THE INVENTION

A construction or renovation project is a collaborative effort that requires the collective skills of a number of different professionals and workers. Architects, engineers, designers, contractors and owners are all involved at various stages of the project, sometimes having very little direct communication with one another. Of course, a building is a complex structure that is constructed using a variety of components including, e.g., windows, doors, heating/ventilation/air conditioning (HVAC) systems, electrical systems, plumbing systems, etc. The various components of the building must be selected and assembled together correctly, as specified by an overall plan for the project, and in accordance with accepted building practices and building codes. It is therefore common practice to produce drawings, models and specifications describing the work that is to be performed and the building components that are to be used. Such documents are utilized by the various professionals and workers during all stages of the project, and are largely responsible for the successful outcome of the project.

The use of computer-aided design and building-information-modeling processes has been gaining popularity in recent years. A Building Information Model (BIM) describes a building structure or topology (e.g., walls, doors, elevators, stairwells, location, shape and boundaries of the compartments, etc.) as semantic objects grouped into standard classes. Each class of objects has standard properties such as physical dimensions, but can also be assigned special properties such as the R-values for windows and doors, fire ratings for doors and walls, and trafficability of a space. Such BIM information can be used to rapidly and automatically generate 3D graphical renderings of buildings, as well as in a range of other applications from energy management to evacuation planning.

Building information models are typically described as assemblies, based on internationally recognized standards of classification such as UniFormat, Masterformat or OmniClass, among others. Such classification systems provide a consistent way to define building model elements, regardless of the complexities of the assemblies or model elements that they represent. It is also a very logical way to categorize building model elements, in which the components of the building are described as assemblies rather than constituent parts.

Specification documents, on the other hand, have been around for many years and little has changed in the way they are prepared. Specifications are written in a linear way, and are structured according to products, activities or construction requirements. For instance, in North America specifications are based on MasterFormat, a 50-division, material-specific organizational format which, according to the Construction Specifications Institute (CSI), is an “organizational standard for specifications and is a master list of titles and numbers classified by work results for organizing data about construction requirements, products, and activities.” The specification document is written by a specification writer and reflects a myriad of decisions that have been made during the design process regarding the components of the building, such as for instance the specific type of each of the components and the number of units of each type of component required, etc. Commercial master specifications currently are provided as word processing files or as a database file. Each word processing file is a separate specification section. In the database iteration, the entire specification is stored in one file. In both cases, the user edits the contents of the master specification to achieve the appropriate information for the project at hand.

Of course, it is desirable to automate the process of creating or updating a specification document based on the information that is contained in a BIM. Automation of such tasks eliminates the need to employ specification writers, and facilitates more frequent updating of the specification document to reflect changes that are made to the BIM during the course of a construction project. Unfortunately, as noted above, often the BIM and the specification document are based on different classification standards. As a result, in many cases, an element does not map uniquely from the classification standard that is used for the BIM to classification standard that is used for the specification document. That is to say, an element is classified in the BIM according to the element type, the dimensions of the element, etc., whereas the same element is further classified in the specification document according to the materials from which the element is fabricated, etc. Since the two classification standards classify the same element with different levels of specificity, a problem arises in that an element in the BIM may be susceptible to being classified within a plurality of different classifications in the specification document. Resolving a one-to-many mapping conflict of this type requires making a decision, such that the element in the BIM can be assigned to a unique classification in the specification document. In the past, a specification writer made this decision based on other information relating to the design requirements for the element.

It would be beneficial to provide a method that overcomes at least some of the above-mentioned limitations and disadvantages of the prior art.

### SUMMARY OF THE INVENTION

In accordance with an aspect of at least one embodiment of the instant invention, there is provided a computer-aided method, comprising: using a computer system, generating a data file including first data indicative of a classification of an element of a construction project, the classification in accordance with a first classification standard, and the data file including second data associated with the first data, the second data indicative of at least a label that is descriptive of the element of the construction project, the at least a label other than in accordance with the first classification standard; applying, by the computer system, a filtering rule based on the at least a label; and automatically mapping the element to a unique classification in accordance with a second classification standard based on the first data and based on a result of applying the filtering rule to the second data, wherein the classification in accordance with the first classification standard corresponds to a plurality of classifications in accordance with the second classification standard, the plurality of classifications including the unique classification.

In accordance with an aspect of at least one embodiment of the instant invention, there is provided a computer-aided method, comprising: receiving, at a computer system, first data that are indicative of a classification of an element of a construction project according to a first classification standard and second data that are associated with the first data, the second data indicative of a label that is descriptive of the element, the label being one of a plurality of predetermined labels; applying, by the computer system, a filtering rule based on the label; and automatically mapping the element to a unique classification of a second classification standard based on the first data and the second data and a result of applying the filtering rule, wherein the classification in accordance with the first classification standard corresponds to a plurality of classifications in accordance with the second classification standard, the plurality of classifications including the unique classification.

In accordance with an aspect of at least one embodiment of the instant invention, there is provided a computer-aided method, comprising: using a process in execution on a processor of a computer system, generating a first data file including first data indicative of a classification of an element of a construction project, the classification being in accordance with the UniFormat classification standard, the first data file further including second data associated with the first data, the second data indicative of at least a label that is descriptive of the element, and the at least a label being other than in accordance with the UniFormat classification standard; implementing, in a mapping module in execution on the processor of the computer system, filtering rules based on the at least a label; and accessing implemented filtering rules, and responsive to the first data and the second data and the implemented filtering rules, automatically mapping the element to a unique number and title of the MasterFormat classification standard.

In accordance with an aspect of at least one embodiment of the instant invention, there is provided a non-transitory computer-readable medium storing computer-readable instructions for implementing a method, the method comprising: generating a first data file including first data indicative of a classification of an element of a construction project, the classification being in accordance with the UniFormat classification standard, the first data file further including second data associated with the first data, the second data indicative of at least a label that is descriptive of the element, and the at least a label being other than in accordance with the UniFormat classification standard; implementing filtering rules based on the at least a label; and accessing implemented filtering rules, and responsive to the first data and the second data and the implemented filtering rules, automatically mapping the element to a unique number and title of the MasterFormat classification standard.

### BRIEF DESCRIPTION OF THE DRAWINGS

The instant invention will now be described by way of example only, and with reference to the attached drawings, wherein similar reference numerals denote similar elements throughout the several views, and in which:

FIG. 1 is a simplified block diagram of a system for implementing embodiments of the invention.

FIG. 2 is a simplified diagram showing non-unique mapping of an element in a BIM to many elements in a specification document, according to a prior art method.

FIG. 3 is a simplified diagram showing unique mapping of an element in a BIM to a single element in a specification document, according to a method in accordance with an embodiment of the instant invention.

FIG. 4 is a simplified flow diagram of a method according to an embodiment of the invention.

FIG. 5 is a simplified flow diagram of a method according to an embodiment of the invention.

FIG. 6 is a simplified flow diagram of a method according to an embodiment of the invention.

### DETAILED DESCRIPTION OF EMBODIMENTS OF THE INVENTION

The following description is presented to enable a person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the scope of the invention. Thus, the present invention is not intended to be limited to the embodiments disclosed, but is to be accorded the widest scope consistent with the principles and features disclosed herein.

Throughout the description and in the appended claims, the term “UniFormat” is intended to encompass variants including but not limited to the following: “UniFormat,” “UniFormat II,” “UniFormat 2010,” “GSA UniFormat,” “ASTM UniFormat” and “R.S. Means UniFormat” or any other similar standard.

With reference to FIG. 1, shown is a simplified block diagram of a representative system for implementing embodiments of the invention. System 100, which may be a general-purpose or special-purpose computer or any one of a variety of other consumer electronic devices, includes processing system 102 and memory 104. Other components of system 100 include one or more mass storage devices 106, input device 108, and output device 110, each of which is discussed in more detail below. Optionally, system 100 is in communication with other remote or local systems via a communication network, such as a Local Area Network (LAN) and/or a Wide Area Network (WAN).

Processing system 102 includes one or more processors, such as a central processor and optionally one or more other processors designed to perform a particular function or task. It is typically the processing system 102 that executes instructions provided on computer-readable media, such as on memory 104, a magnetic hard disk, a removable magnetic disk, a magnetic cassette, an optical disk, a flash memory device, a USB device, or from a communication connection, which may also be viewed as a computer-readable medium.

Memory 104 includes one or more computer-readable media that may be configured to include or includes thereon data or instructions for manipulating data, and may be accessed by processing system 102. Mass storage device 106 provides non-volatile storage of data and/or executable instructions that may include one or more program modules such as an operating system, one or more application programs, other program modules, or program data. Such executable instructions are examples of program code for implementing steps for methods disclosed herein.

The system 100 includes one or more input devices 108 to enable a user to enter data and/or instructions. Examples of such input devices include a keyboard and alternate input devices, such as a mouse, trackball, stylus, touchscreen, or other pointing device, etc. Additionally, the system 100 includes one or more output devices 110 for providing human intelligible information to the user. Examples of output devices include a monitor or display screen, a speaker, a printer, and the like.

As noted above, optionally the system 100 is in communication with other systems via a communication network, such as for instance the Internet. In a networked system, accessible program modules or portions thereof may be stored in a remote memory storage device. As such, the system 100 may participate in a distributed computing environment, where functions or tasks are performed by a plurality of networked devices.

FIG. 2 is a simplified diagram showing the non-unique mapping of an element in a BIM to a plurality of elements in a specification document, according to a prior art method. In the BIM, Element A is classified in accordance with a first classification standard, such as for instance the UniFormat classification standard. More particularly Element A is classified based on element type and based on dimensions of the element. In the example that is shown in FIG. 2, mapping of Element A from the BIM to the specification document is a non-unique, one-to-many mapping. This is because the specification document is based on a classification standard, for instance MasterFormat, which takes into account additional properties of the element, such as for instance the material from which the element is fabricated, the color, finish, water resistance treatment, etc. In the specific example that is depicted in FIG. 2, Element A maps onto three classifications in the specification document, each of the three classifications being associated with different material compositions. Since the mapping of Element A is non-unique, a user must perform a manual selection to resolve the mapping uncertainty. For instance, the user specifies that Element A is fabricated from metal and thereby resolves the mapping uncertainty. The prior art method clearly is not well suited to being automated, due to the need to receive input from a user in order to resolve non-unique mapping conflicts.

FIG. 3 is a simplified diagram showing the unique mapping of an element in a BIM to a single element in a specification document, in accordance with an embodiment of the instant invention. In the BIM, Element A is classified in accordance with a first classification standard, such as for instance the UniFormat classification standard. More particularly Element A is classified based on element type and based on dimensions of the element. In addition, a label is associated with Element A describing the material from which Element A is fabricated. By way of an example, the label specifies that Element A is fabricated from metal. The UniFormat identifier for Element A maps onto a set of three MasterFormat identifiers in the specification document, as is depicted in FIG. 3 using the dashed lines and the solid line. Implementing filtering rules based on the label then resolves the one-to-many mapping conflict, such that the UniFormat identifier for Element A maps onto only one MasterFormat identifier in the specification document, as depicted using the solid line.

In this specific example the label relates to the material from which Element A is fabricated, but alternatively the label is descriptive of another suitable property of the Element A. For instance, the label optionally relates to color, water resistance treatment, finish, order of completion in the project, commercial or residential, etc. Further, the label optionally includes synonyms and/or abbreviations for the material from which Element A is fabricated. Further optionally, the label is descriptive of more than one material from which Element A is fabricated, such as for instance wood/vinyl/aluminum. The primary material may be so identified and/or ranked higher than the other, minor materials.

Referring now to FIG. 4, shown is a simplified flow diagram of a method according to an embodiment of the invention. More particularly, FIG. 4 depicts a computer-aided method for resolving mapping conflicts during propagating of information between a building information model (BIM) and a specification document associated with a project. The BIM is a data file, which is created using computer aided design software such as for instance the Revit® products that are offered by Autodesk®. The specification document is for instance a word processing file or a database file. Both the BIM and the specification document are created during the planning and design stage of the project, and either one may be changed during the course of the project in response to design changes or in the event that unexpected problems are encountered, etc.

As discussed previously a first classification standard is used to classify elements in the BIM, and a second classification standard is used to classify elements in the specification document. By way of a specific and non-limiting example, the BIM is based on the UniFormat classification standard and the specification document is based on the MasterFormat classification standard. As will be apparent, the MasterFormat classification standard includes many more classes than does the UniFormat classification standard. As a result, mapping from the BIM to the specification document may result in mapping uncertainties, such as for instance a one-to-many mapping conflict. That is to say, an element in the BIM may map onto a set of classifications in the specification document, the set of classifications relating to different materials from which the element is fabricated or to other characteristic properties of the element.

Referring still to FIG. 4, at 400 a computer system is used to generate a data file including first data that are indicative of a classification of an element of a construction project, the classification in accordance with a first classification standard. In the instant example the generated data file is a BIM and the first classification standard is the UniFormat classification standard. The generated data file further includes second data that are associated with the first data, the second data indicative of at least a label that is descriptive of the element of the construction project, and the at least a label being other than in accordance with the first classification standard. For instance, the label is a keyword that is descriptive of a property of the element, such as for instance the material from which the element is fabricated, or another characteristic property of the element. At 402 the element is mapped from the first classification standard to a set of classifications of a second classification standard. In the instant example, the second classification standard is the MasterFormat classification standard. The set of classifications relate to, e.g., different materials from which the element is fabricated. As will be apparent, mapping from the Uniformat standard to the MasterFormat standard in this case results in a one-to-many mapping conflict. In order to resolve the one-to-many mapping conflict, at 404 a filtering rule is applied based on the at least a label that is associated with the first data. At 406 the element is mapped automatically to a unique classification of the set of classifications, based on the first data and based on a result of applying the filtering rule to the second data.

In the example that is discussed with reference to FIG. 4 the second data relates to a material from which the element is fabricated. The second data optionally includes synonyms and/or abbreviations that describe the material from which the element is fabricated. The second data optionally relates to additional materials from which the element is fabricated, optionally the primary material being ranked higher than other materials. Further optionally, the second data relates to other characteristic properties of the element, e.g., color, water resistance treatment, finish or order of completion in the project.

Referring now to FIG. 5, shown is a simplified flow diagram of a method according to an embodiment of the invention. More particularly, FIG. 5 depicts a computer-aided method for resolving mapping conflicts during propagating of information between a building information model (BIM) and a specification document associated with a project. As discussed previously with reference to FIG. 4, the BIM is a data file, which is created using computer aided design software such as for instance the Revit® products that are offered by Autodesk®. The specification document is for instance a word processing file or a database file. Both the BIM and the specification document are created during the planning and design stage of the project, and either one may be changed during the course of the project in response to design changes or in the event that unexpected problems are encountered, etc.

As discussed previously a first classification standard is used to classify elements in the BIM, and a second classification standard is used to classify elements in the specification document. By way of a specific and non-limiting example, the BIM is based on the UniFormat classification standard and the specification document is based on the MasterFormat classification standard. As will be apparent, the MasterFormat classification standard includes many more classes than does the UniFormat classification standard. As a result, mapping from the BIM to the specification document may result in mapping uncertainties, such as for instance a one-to-many mapping. That is to say, an element in the BIM may map onto a set of classifications in the specification document, the set of classifications relating to different materials from which the element is fabricated.

At 500 first data and second data are received at a computer system, the first data being indicative of a classification of an element of a construction project according to a first classification standard and the second data associated with the first data and being indicative of a label that is descriptive of the element. For instance the label is one of a plurality of predetermined labels relating to materials from which the element is fabricated. At 502 a filtering rule is applied by the computer system, the filtering rule based on the label. At 504 the element is automatically mapped to a unique classification of a second classification standard based on the first data and the second data and a result of applying the filtering rule.

In this specific example the label relates to the material from which the element is fabricated, but alternatively the label is descriptive of another suitable property of the element. For instance, the label optionally relates to color, water resistance treatment, finish, order of completion in the project, commercial or residential, etc. Further, the label optionally includes synonyms and/or abbreviations for the material from which the element is fabricated. Further optionally, the label is descriptive of more than one material from which the element is fabricated, such as for instance wood/vinyl/aluminum. The primary material may be so identified and/or ranked higher than the other, minor materials.

Referring now to FIG. 6, shown is a simplified flow diagram of a method according to an embodiment of the invention. More particularly, FIG. 6 depicts a computer-aided method for resolving mapping conflicts during propagating of information between a building information model (BIM) and a specification document associated with a project. As discussed previously with reference to FIG. 4, the BIM is a data file, which is created using computer aided design software such as for instance the Revit® products that are offered by Autodesk®. The specification document is for instance a word processing file or a database file. Both the BIM and the specification document are created during the planning and design stage of the project, and either one may be changed during the course of the project in response to design changes or in the event that unexpected problems are encountered, etc.

As discussed previously a first classification standard is used to classify elements in the BIM, and a second classification standard is used to classify elements in the specification document. By way of a specific and non-limiting example, the BIM is based on the UniFormat classification standard and the specification document is based on the MasterFormat classification standard. As will be apparent, the MasterFormat classification standard includes many more classes than does the UniFormat classification standard. As a result, mapping from the BIM to the specification document may result in mapping uncertainties, such as for instance a one-to-many mapping conflict. That is to say, an element in the BIM may map onto a set of classifications in the specification document, the set of classifications relating to different materials from which the element is fabricated.

At 600, using a process in execution on a processor of a computer system, a first data file is generated. The first data file includes first data that are indicative of a classification of an element of a construction project, the classification being in accordance with the UniFormat classification standard. The first data file further includes second data associated with the first data, the second data indicative of at least a label that is descriptive of the element, and the at least a label being other than in accordance with the Uniformat classification standard. At 602 filtering rules are implemented, in a mapping module in execution on the processor of the computer system, based on the at least a label. At 604 implemented filtering rules are accessed and, responsive to the first data and the second data and the implemented filtering rules, the element is automatically mapped to a unique number and title of the MasterFormat classification standard.

In this specific example the label relates to the material from which the element is fabricated, but alternatively the label is descriptive of another suitable property of the element. For instance, the label optionally relates to color, water resistance treatment, finish, order of completion in the project, commercial or residential, etc. Further, the label optionally includes synonyms and/or abbreviations for the material from which the element is fabricated. Further optionally, the label is descriptive of more than one material from which the element is fabricated, such as for instance wood/vinyl/aluminum. The primary material may be so identified and/or ranked higher than the other, minor materials.

The methods described herein, with specific reference to FIGS. 4-6, resolve uncertainties that arise during mapping of elements between different classification standards, such as for instance between the UniFormat classification standard and the MasterFormat classification standard. Such mapping uncertainties arise, e.g., during the automated propagation of information between a BIM and a specification document, as described in the commonly assigned co-pending application entitled “Method For Propagating Information Between A Building Information Model And A Specification Document.” When an element that is defined in the BIM is not also defined in the specification document, then in order to update the specification document to include the element it is necessary to first determine the correct classification of the element according to the MasterFormat classification standard. Once the element is correctly classified, it then becomes possible to update the specification document in an automated fashion.

While the above description constitutes a plurality of embodiments of the present invention, it will be appreciated that the present invention is susceptible to further modification and change without departing from the fair meaning of the accompanying claims.

What is claimed is:

1. A computer-aided method, comprising:
using a computer system, generating a data file including first data indicative of a classification of an element of a construction project, the classification in accordance with a first classification standard, and the data file including second data associated with the first data, the second data indicative of at least a label that is descriptive of the element of the construction project, the at least a label other than in accordance with the first classification standard;
applying, by the computer system, a filtering rule based on the at least a label; and
automatically mapping the element to a unique classification in accordance with a second classification standard based on the first data and based on a result of applying the filtering rule to the second data,
wherein the classification in accordance with the first classification standard corresponds to a plurality of classifications in accordance with the second classification standard, the plurality of classifications including the unique classification.

2. The method of claim 1 wherein the first classification standard is the UniFormat classification standard, the second classification standard is the MasterFormat classification standard, and wherein the unique classification of the second classification standard corresponds to a unique number and title of the MasterFormat classification standard.

3. The method of claim 1 comprising, upon mapping the element to the unique classification in accordance with the second classification standard, automatically updating a second data file with the unique classification.

4. The method of claim 3 wherein the first data file is a building information model (BIM) and wherein the second data file is a specification document for the construction project.

5. The method of claim 1 wherein the at least a label is descriptive of one of a property of the element and a material from which the element is fabricated.

6. The method of claim 5 wherein the at least a label is one of a synonym and an abbreviation for the material from which the element is fabricated.

7. The method of claim 1 wherein the at least a label comprises a plurality of labels, each label of the plurality of labels being descriptive of a different material from which the element is fabricated.

8. The method of claim 1 wherein the at least a label is descriptive of at least one of a color, a water resistance treatment, a finish, an order of completion in the project, and a commercial or residential designation of the element.

9. A computer-aided method, comprising:
receiving, at a computer system, first data that are indicative of a classification of an element of a construction project according to a first classification standard and second data that are associated with the first data, the second data indicative of a label that is descriptive of the element, the label being one of a plurality of predetermined labels;
applying, by the computer system, a filtering rule based on the label; and
automatically mapping the element to a unique classification of a second classification standard based on the first data and the second data and a result of applying the filtering rule,
wherein the classification in accordance with the first classification standard corresponds to a plurality of classifications in accordance with the second classification standard, the plurality of classifications including the unique classification.

10. The method of claim 9 wherein the first classification standard is the UniFormat classification standard, the second classification standard is the MasterFormat classification standard, and wherein the unique classification of the second classification standard corresponds to a unique number and title of the MasterFormat classification standard.

11. The method of claim 10 comprising, upon mapping the element to the unique classification in accordance with the second classification standard, automatically updating a second data file with the unique classification.

12. The method of claim 11 wherein the first data file is a building information model (BIM) and wherein the second data file is a specification document for the construction project.

13. The method of claim 9 wherein the label is descriptive of one of a property of the element and a material from which the element is fabricated.

14. The method of claim 13 wherein the label is one of a synonym and an abbreviation for the material from which the element is fabricated.

15. The method of claim 9 wherein the label is descriptive of at least one of a color, a water resistance treatment, a finish, an order of completion in the project, and a commercial or residential designation of the element.

16. A computer-aided method, comprising:
using a process in execution on a processor of a computer system, generating a first data file including first data indicative of a classification of an element of a construction project, the classification being in accordance with the UniFormat classification standard, the first data file further including second data associated with the first data, the second data indicative of at least a label that is descriptive of the element, and the at least a label being other than in accordance with the Uniformat classification standard;
implementing, in a mapping module in execution on the processor of the computer system, filtering rules based on the at least a label; and
accessing implemented filtering rules, and responsive to the first data and the second data and the implemented filtering rules, automatically mapping the element to a unique number and title of the MasterFormat classification standard.

17. The method of claim 16 comprising, upon mapping the element to the unique number and title of the MasterFormat classification standard, automatically updating a second data file with the unique number and title.

18. The method of claim 17 wherein the first data file is a building information model (BIM) and wherein the second data file is a specification document for the construction project.

19. The method of claim 16 wherein the at least a label is descriptive of one of a property of the element and a material from which the element is fabricated.

20. The method of claim 19 wherein the at least a label is one of a synonym and an abbreviation for the material from which the element is fabricated.

21. The method of claim 16 wherein the at least a label comprises a plurality of labels, each label of the plurality of labels being descriptive of a different material from which the element is fabricated.

22. The method of claim 16 wherein the at least a label is descriptive of at least one of a color, a water resistance treatment, a finish, an order of completion in the project, and a commercial or residential designation of the element.

23. A non-transitory computer-readable medium storing computer-readable instructions for implementing a method, the method comprising:
generating a first data file including first data indicative of a classification of an element of a construction project, the classification being in accordance with the UniFormat classification standard, the first data file further including second data associated with the first data, the second data indicative of at least a label that is descriptive of the element, and the at least a label being other than in accordance with the Uniformat classification standard;
implementing filtering rules based on the at least a label; and
accessing implemented filtering rules, and responsive to the first data and the second data and the implemented filtering rules, automatically mapping the element to a unique number and title of the MasterFormat classification standard.
